(19) United States
(12) Patent Application Publication
(10) Pub. No.: US 2023/0258518 A1
(43) Pub. Date: Aug. 17, 2023

(54) STEERING SYSTEM AND SENSOR MODULE FOR A STEERING SYSTEM

(71) Applicant: ZF FRIEDRICHSHAFEN AG, Friedrichshafen (DE)

(72) Inventor: Ingo BECKER, Linnich (DE)

(21) Appl. No.: 18/018,071

(22) PCT Filed: Jul. 22, 2021
(86) PCT No.: PCT/EP2021/070591

§ 371 Date: Jan. 26, 2023

(30) Foreign Application Priority Data
Jul. 28, 2020 (DE) 10 2020 209 463.2

(51) Int. Cl. G01L 5/22; G01B 7/30; G01L 3/10; B62D 15/02

(52) U.S. Cl. CPC G01L 5/221; G01B 7/30; G01L 3/104; B62D 15/0215

(57) ABSTRACT

The present invention relates to a sensor module (100) for a steering system (200) of a vehicle. The sensor module (100) comprises a torque sensor (110), which is designed to identify a steering torque transmitted by the steering system (200), and a rotation angle sensor (120), which is designed to identify an absolute steering angle of the steering system (200). Furthermore, the sensor module (100) comprises a housing (130) for accommodating the torque sensor (110) and the rotation angle sensor (120), wherein the housing (130) has at least one connecting element (132) for detachable attachment to the steering system (200).

### TECHNICAL FIELD

The present invention relates to a steering system and a sensor module for a steering system. In particular, the present invention relates to a sensor module for determining a steering torque transmitted by a steering system and an absolute steering angle.

### BACKGROUND

In motor vehicles, the steering torque and the absolute steering angle can serve as input variables in electrical steering systems. The steering torque and the absolute steering angle are used here, for example, to regulate an electronic actuation of a steering system in motor vehicles.

In known concepts, a sensor arrangement with a steering angle sensor and a steering torque sensor is used to detect the steering torque and the absolute steering angle.

Document DE 10 2010 020 599 A1 describes a sensor arrangement for motor vehicle steering systems with a torque sensor for magnetically determining a steering torque and a rotation angle sensor for magnetically determining an absolute steering angle. The torque sensor and the rotation angle sensor jointly use exactly one carrier element with magnetic coding to determine the steering torque and the absolute steering angle. Due to contamination in the area of the sensor arrangement, in particular between the carrier element and the rotation angle sensor and/or the torque sensor, there may be an increase in inaccuracy when detecting the steering torque and the absolute steering angle. Replacing the sensor arrangement in the event of a defect is only possible with great effort.

### SUMMARY

There is therefore a need for an improved concept for detecting a steering torque and an absolute steering angle, in particular for reducing inaccuracy caused by contamination when detecting the steering torque and the absolute steering angle.

This need can be met by the subject matter of the independent and dependent claims disclosed herein.

According to a first aspect, the present invention relates to a sensor module for a steering system of a vehicle. The sensor module comprises a torque sensor, which is designed to identify a steering torque transmitted by the steering system, and a rotation angle sensor, which is designed to identify an absolute steering angle of the steering system. In addition, the sensor module comprises a housing for accommodating the torque sensor and the rotation angle sensor, wherein the housing has at least one connecting element for detachable attachment to the steering system.

The steering system is suitable, for example, for controlling a motor vehicle, such as a passenger vehicle (car) or a heavy goods vehicle (truck).

The steering torque is to be understood as a torque which is transmitted via the steering system in order to steer the vehicle. The steering torque is, for example, the torque that is introduced into the steering system when a driver of the vehicle gives a steering command and is transmitted by the steering system to steer one or more wheels of the vehicle.

The absolute steering angle is to be understood, for example, as an angle by which a shaft of the steering system which is provided for receiving and/or transmitting the steering torque is rotated in total relative to a reference position which the shaft assumes in a basic position of the steering system. With more than one “whole” or full revolution of the shaft from the reference position, the absolute steering angle assumes values of more than 360°, for example.

Accordingly, the rotation angle sensor can be designed as a so-called “multi-turn sensor”, which is designed in particular to detect the absolute steering angle.

The torque sensor and the rotation angle sensor are designed in particular for “contactless” detection of the steering torque or the absolute steering angle.

In general, the absolute steering angle can assume both positive and negative values, depending on the direction of rotation of the shaft relative to the reference position.

The housing can enclose the torque sensor and the rotation angle sensor at least partially and, for accommodating these sensors inside the housing, can comprise means for arranging the torque sensor and the rotation angle sensor inside the housing. Through the housing, penetration of dirt, dust and/or moisture to the sensors can be at least reduced. In this way, contamination in the area of the sensors can be reduced and an associated deterioration in inaccuracy when detecting the absolute steering angle and steering torque can be reduced.

Due to the detachable attachment of the housing to the steering system, the sensor module can be replaced. This means that the sensor module can be replaced for maintenance purposes, for example.

By (externally) attaching the housing to the steering system, the sensors can be brought together into a position for (contactless) detection of the steering torque and the absolute steering angle.

In exemplary embodiments in which the sensors are designed for contactless detection of the steering torque and the absolute steering angle, no mechanical coupling (“without steering angle gear”) to the steering system is required when attaching the sensor module to the steering system. Compared to concepts that provide a mechanical coupling (with a steering angle gear) to the steering system for detecting the steering torque and the absolute steering angle, there can therefore be less assembly effort when attaching the sensor module.

In some exemplary embodiments, the connecting element has at least one recess for a screw connection for connection to the steering system.

In some exemplary embodiments, the connecting element has at least one plug-in element for the plug-in connection to the steering system.

The plug-in element is embodied, for example, in such a way that the sensor module can be attached to the steering system and/or detached from the steering system without the use of tools.

In some exemplary embodiments, the housing completely encloses the torque sensor and the rotation angle sensor.

The housing surrounds the torque sensor and the rotation angle sensor, for example, in every direction. This allows the penetration of dirt, dust and/or moisture from all directions and thus overall contamination in the area of the sensors to be reduced at least within the housing.

In some exemplary embodiments, the housing is sealed in a dustproof and/or waterproof manner.

The dustproof and/or waterproof housing can ideally prevent the penetration of dust or moisture/water to the sensors completely.

In some exemplary embodiments, the torque sensor is designed to identify the steering torque magnetically in interaction with a magnet arrangement which is arranged on a shaft of the steering system to receive the steering torque. The rotation angle sensor can be designed to identify the absolute steering angle magnetically in interaction with the magnet arrangement.

The shaft corresponds, for example, to a steering column of the steering system.

The magnet arrangement comprises, for example, several differently aligned magnets which are arranged around the shaft in the circumferential direction. In addition, the magnet arrangement can be arranged on the shaft in a rotationally fixed (“integrated”) manner.

The rotation angle sensor comprises, for example, one or more magnetic field sensors and a magnetoresistive structure whose electrical resistance changes with a change in a magnetic field emanating from the magnet arrangement. The magnetic field sensors can measure a magnetic flux density of a magnetic field emanating from the magnet arrangement. The measured magnetic flux density and the electrical resistance of the magnetoresistive structure can be used to detect the absolute steering angle. This enables contactless and magnetic detection of the absolute steering angle.

The torque sensor comprises a magnetic field sensor, for example. The magnetic field sensor is designed, for example, to identify the magnetic flux density of the magnetic field, the value of which depends in particular on the steering torque. This enables contactless and magnetic detection of the steering torque.

With contactless detection, for example, no mechanical coupling of the torque sensor or the rotation angle sensor to the steering system is required. For example, it is not necessary to couple the steering column to the sensors via a gearbox.

In some exemplary embodiments, a housing side of the housing that faces the magnet arrangement is permeable to a magnetic field of the magnet arrangement.

The housing side facing the magnet arrangement is, for example, at least partially made of paramagnetic and/or diamagnetic material.

In particular, this allows magnetic detection of the absolute steering angle and steering torque, as described above. At the same time the penetration of dirt, dust and/or moisture to the sensors from the magnet arrangement can be reduced.

In some exemplary embodiments, the sensor module comprises at least one magnetic flux concentrator, which is designed to direct a magnetic field of the magnet arrangement to the torque sensor or the rotation angle sensor.

As is understandable for a person skilled in the art, this means, for example, that the signal quality of the torque and/or rotation angle sensor is improved. Better signal quality results, for example, in greater accuracy when detecting the absolute steering angle or the steering torque.

In some exemplary embodiments, the torque sensor comprises a first magnetic field sensor and at least one second magnetic field sensor.

In some exemplary embodiments, the sensor module comprises a torque sensor for electromagnetic, optical, capacitive or inductive determination of the steering torque.

In some exemplary embodiments, the torque sensor and the rotation angle sensor are attached to a common printed circuit board.

Compared to concepts that provide for the torque sensor and the rotation angle sensor to be attached to separate printed circuit boards, a number of components can be reduced in this way, and production costs can therefore be reduced.

In some exemplary embodiments, the sensor module comprises an interface coupled to the torque sensor and the rotation angle sensor for outputting a signal generated by the torque sensor and the rotation angle sensor.

The signal comprises, for example, sensor data from the torque sensor for determining the steering torque and further sensor data from the rotation angle sensor for determining the absolute steering angle. Therefore, both the absolute steering angle and the steering torque can be determined using the signal.

The interface is, for example, an interface for serial or parallel data transmission.

Since the interface can be used to detect the sensor data from both the torque sensor and the rotation angle sensor, there is no need for respective separate interfaces for the torque sensor and the rotation angle sensor. In this way, costs can be saved.

According to a further aspect, the present invention relates to a steering system for a vehicle. The steering system comprises one of the previous exemplary embodiments of a sensor module for determining a steering torque transmitted by the steering system and an absolute steering angle.

### BRIEF DESCRIPTION OF THE DRAWINGS

A few examples of exemplary embodiments of the invention are explained in more detail below with reference to the accompanying figures, merely by way of example. In the figures:

FIG. 1 shows a sensor module for determining an absolute steering angle and a steering torque in a steering system;

FIG. 2a shows a counting device for determining the absolute steering angle in a first scenario; and

FIG. 2b shows the counting device for determining the absolute steering angle in a second scenario.

### DESCRIPTION

Although exemplary embodiments can be modified and altered in various ways, exemplary embodiments are represented in the figures as examples and are described in detail herein. It should be understood, however, that exemplary embodiments are not to be limited to the particular forms disclosed, but rather that exemplary embodiments should cover all functional and/or structural modifications, equivalents and alternatives that are within the scope of the invention.

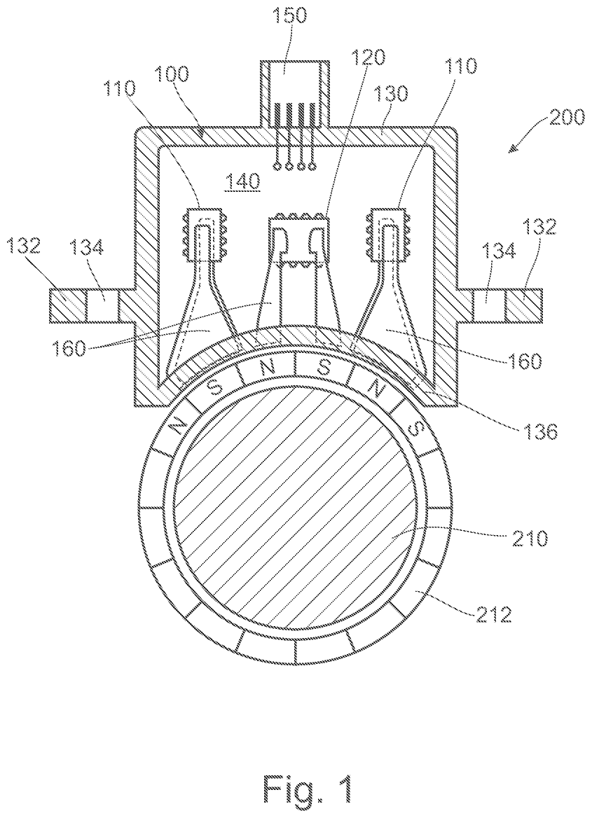

FIG. 1 shows a sensor module 100 for determining an absolute steering angle and a steering torque in a steering system 200.

In the example shown, the sensor module 100 comprises two torque sensors 110 for identifying a steering torque transmitted by the steering system 200. In addition, the sensor module 100 comprises a rotation angle sensor 120 for identifying the absolute steering angle. Further, the sensor module 100 has a housing 130 for accommodating the torque sensors 110 and the rotation angle sensor 120. For the detachable attachment of the sensor module 100 to the steering system 200, the housing 130 has a respective connecting element 132 on opposite housing sides.

In the example shown, the connecting elements 132 are each provided with a recess 134 for a screw connection for attachment to the steering system 200. Alternatively, the connecting elements can each be embodied as a clamp, which is used for a plug-in connection to the steering system.

The torque sensors 110 and the rotation angle sensor 120 are each embodied as an application-specific integrated circuit (ASIC) and applied to a common printed circuit board 140.

The torque sensors 110 and the rotation angle sensor 120 of the sensor module 130 are attached in the radial direction adjacent to a rotatable shaft 210 of the steering system 200 provided for transmitting the steering torque and to a magnet arrangement 212 arranged around the shaft 210. The shaft 210 is rotatable relative to the sensor module 100.

The magnet arrangement 212 has a plurality of magnets arranged adjacently in the circumferential direction, as a result of which an arrangement of magnetic polarities that changes in the circumferential direction, a so-called “magnetic coding”, is formed. The magnet arrangement 212 is coupled to the shaft 210 in a rotationally fixed manner, for example.

When the shaft 210 rotates, the magnetic coding of the magnet arrangement 212 is rotated relative to the sensor module 100 so that the magnetic poles are moved past the rotation angle sensor 120.

The rotation angle sensor 120 comprises, for example, a magnetic field sensor and a counting device. The magnetic field sensor can measure a magnetic flux density of a magnetic field emanating from the magnet arrangement. The counting device is designed to sense a total number of magnetic poles that have moved past the rotation angle sensor 120 when the shaft 210 is rotated relative to a reference position in a first or second direction of rotation. Knowing the angular segments assigned to the magnetic poles, the absolute steering angle can be inferred using the sensed number of magnetic poles that were moved past the rotation angle sensor 120 and the measured magnetic flux density.

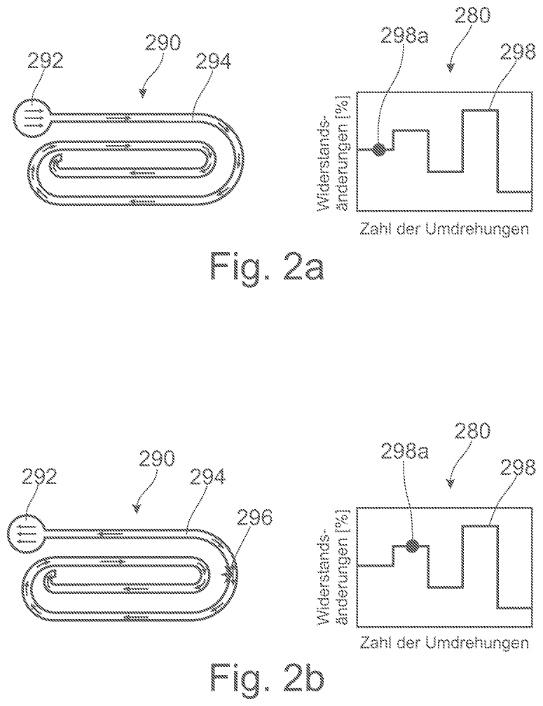

FIGS. 2a and 2b show an example of a possible functional principle of such a counting device.

FIGS. 2a and 2b show an example of a counting device 290. The counting device 290 comprises a so-called “domain wall generator” 292 and a magnetoresistive structure 294 coupled thereto. When different magnetic poles move past the counting device 290, the domain wall generator 292 changes its magnetization and generates a domain wall 296. The domain wall 296 accumulates within the magnetoresistive structure 294 to achieve an energetically favorable state.

FIG. 2a shows a first state of the counting device 290 in which no domain wall has (yet) accumulated within the magnetoresistive structure 294. The first state indicates, for example, the reference position of the shaft 210.

FIG. 2b shows a second state of the counting device 290 in which the domain wall 296 has accumulated within the magnetoresistive structure 294. The second state occurs, for example, when the shaft 210 is rotated by a specific angular segment, so that exactly one magnetic polarity of the magnet arrangement 212 has been moved past the counting device 290.

The further the shaft 210 is twisted in relation to the reference position, the more domain walls can accumulate in the magnetoresistive structure 294 according to the principle described above. An electrical resistance of the magnetoresistive structure 294 can change depending on the number and polarity of the domain walls accumulated in the magnetoresistive structure 294.

FIGS. 2a and 2b each show a diagram 280 in which a course 298 of the electrical resistance of the magnetoresistive structure 294 is plotted against the rotation of the shaft 210 as an example.

As can be seen from FIGS. 2a and 2b, a first resistance value 298a of the magnetoresistive structure 294 in the first state of the counting device 290 is lower than a second resistance value 298b of the magnetoresistive structure 294 in the second state of the counting device 290.

The absolute steering angle can be inferred from the measured magnetic flux density and the electrical resistance of the magnetoresistive structure 294.

The torque sensors 110 each comprise, for example, a magnetic field sensor (not shown) for magnetic determination of the steering torque. To determine the steering torque, yoke structures are used, for example, which are arranged together with the magnet arrangement on an input and output shaft with a so-called “torsion bar”, which twists to different degrees depending on the steering torque. This allows the yoke structures to rotate relative to the magnet assembly 212 depending on the steering torque. Twisting of the yoke structures relative to the magnet arrangement 212 can in turn affect a magnetic flux density of a magnetic field emanating from the magnet arrangement 212 that prevails at the torque sensors 110, so that different values for the magnetic flux density result at the torque sensors 110 depending on the steering torque. Therefore, the steering torque can be inferred from a value for the magnetic flux density, which is measured in each case by the magnetic field sensors.

The use of several torque sensors, as in the example shown in FIG. 1, serves in particular to increase the fail-safety of the sensor module compared to a single torque sensor due to the redundancy of the several torque sensors relative to one another. In addition, robustness and diagnostic capability can thereby be increased compared to a single torque sensor.

The magnetic determination of the absolute steering angle and the steering torque means in particular a contactless determination of these. Thus, no mechanical coupling of the shaft 210 to the sensor module 100 is required when assembling the sensor module 100, for example by means of a gear. As a result, for example, the expense and susceptibility to errors in assembly are lower than in the case of sensor arrangements which provide a mechanical coupling to steering systems. When assembling the sensor module 100, it is not necessary, for example, in contrast to such sensor arrangements, to ensure that the above-mentioned transmission is correctly coupled to the steering system in order to avoid damage resulting, for example, from an unwanted tooth jump. In contrast to this, a so-called “blind assembly” is possible with the sensor module 100, for example.

In contrast to sensor arrangements that provide a mechanical coupling to the steering system via a gear, the sensor module 100 shown here can be understood as “gearless”.

An advantage of the contactless determination can be seen in the fact that the housing 130 can be created to be impervious to dirt and moisture, since there is no mechanical coupling of the steering system to the sensor module 100 through the housing 130.

As indicated in FIG. 1, the housing 130 is, for example, waterproof and/or dustproof in order to ideally prevent dirt or contamination within the housing 130, which influence the magnetic field of the magnet arrangement 212.

In order to enable a magnetic determination of the steering torque and the absolute rotation angle by the torque sensors or the rotation angle sensor, a housing side 136 facing the magnet arrangement 212 is permeable to the magnetic field emanating from the magnet arrangement 212. For example, the housing side 136 is at least partially fabricated from a diamagnetic or paramagnetic and non-conductive material.

In addition, the housing side 136 is adapted to a shape of the magnet arrangement 212 such that the housing side 136 runs parallel to the magnet arrangement 212. Possible contamination can therefore only occur in an air gap between the magnet arrangement 212 and the housing side 136. In general, the contamination can thus be lower compared to exemplary embodiments with a different configuration of the housing side facing the magnet arrangement 212.

In order to direct the magnetic field to the torque sensors, the sensor module 100 has magnetic flux concentrators 160, one pair of which is assigned to one of the torque sensors 110 and the rotation angle sensor 120.

The torque sensors 110 and the rotation angle sensor 120 each generate, for example, a digital signal that indicates the steering torque or the absolute rotation angle. These signals can be forwarded to an interface 150 via the printed circuit board 140 and can be led out of the housing 130 through this, so that the signals can be tapped outside of the housing 130 for further processing.

Furthermore, the following claims are hereby incorporated into the Detailed Description, wherein each claim may stand on its own as a separate example. While each claim may stand on its own as a separate example, it should be noted that although a dependent claim in the claims may relate to a particular combination with one or more other claims, other examples can also comprise a combination of the dependent claim and the subject-matter of each other dependent or independent claim. Such combinations are explicitly suggested herein unless it is indicated that a particular combination is not intended. Further, features of a claim are also intended to be included for any other independent claim, even if that claim is not made directly dependent on the independent claim.

### REFERENCE NUMERALS

100 sensor module
110 torque sensor/s
120 rotation angle sensor
130 housing
132 connecting element
134 recess
136 housing side
140 printed circuit board
150 interface
160 magnetic flux concentrator
200 steering system
210 shaft
212 magnet arrangement
280 diagram
290 counting device
292 domain wall generator
294 magnetoresistive structure
296 domain wall
298 course of the electrical resistance
298a first resistance value
298b second resistance value

1. A sensor module (100) for a steering system (200) of a vehicle, the sensor module (100) comprising:
at least one torque sensor (110) which is designed to identify a steering torque transmitted by the steering system (200);
at least one rotation angle sensor (120) which is designed to identify a steering angle of the steering system (200); and
a housing (130) for accommodating the torque sensor (110) and the rotation angle sensor (120), wherein the housing (130) has at least one connecting element (132) for detachable attachment to the steering system (200).

2. The sensor module (100) according to claim 1, wherein the connecting element (132) has at least one recess (134) for a screw connection for connection to the steering system (200).

3. The sensor module (100) according to claim 1, wherein the connecting element (132) has at least one plug-in element for plug-in connection to the steering system (200).

4. The sensor module (100) according to claim 1, wherein the housing (130) completely surrounds the torque sensor (110) and the rotation angle sensor (120).

5. The sensor module (100) according to claim 1, wherein the housing (130) is sealed in a dustproof and/or waterproof manner.

6. The sensor module (100) according to claim 1,
wherein the torque sensor (110) is designed to identify the steering torque magnetically in interaction with a magnet arrangement (212) which is arranged on a shaft (210) of the steering system (200) for receiving the steering torque; and
wherein the rotation angle sensor (110) is designed to identify the absolute steering angle magnetically in interaction with the magnet arrangement (212).

7. The sensor module (100) according to claim 6, wherein a housing side (136) of the housing (130) facing the magnet arrangement (212) is permeable to a magnetic field of the magnet arrangement (212).

8. The sensor module (100) according to claim 6, further comprising at least one magnetic flux concentrator (160) which is designed to direct a magnetic field of the magnet arrangement (212) to the torque sensor (110) or the rotation angle sensor (120).

9. The sensor module (100) according to claim 6, wherein the torque sensor (110) comprises a first magnetic field sensor and at least one second magnetic field sensor.

10. The sensor module (100) according to claim 1, comprising a torque sensor for electromagnetic, optical, capacitive, or inductive determination of the steering torque.

11. The sensor module (100) according to claim 1, wherein the torque sensor (110) and the rotation angle sensor (120) are mounted on a common printed circuit board (140).

12. The sensor module (100) according to claim 1, further comprising an interface (150) coupled to the torque sensor (110) and the rotation angle sensor (120) for outputting a signal generated by the torque sensor (110) and the rotation angle sensor (120).

13. A steering system (200) for a vehicle, comprising a sensor module (100) according to claim 1 for determining a steering torque transmitted by the steering system (200) and an absolute steering angle.
